(19) United States
(12) Patent Application Publication
(10) Pub. No.: US 2010/0329097 A1
(43) Pub. Date: Dec. 30, 2010

(54) MULTILAYERED OPTICAL DISC AND ITS RECORDING METHOD

(75) Inventors: Harukazu Miyamoto, Higashimurayama (JP); Takahiro Kurokawa, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Consumer Electronics Co., Ltd.

(21) Appl. No.: 12/569,151

(22) Filed: Sep. 29, 2009

(30) Foreign Application Priority Data
Jun. 24, 2009 (JP) 2009-149295

(51) Int. Cl. G11B 7/00; B32B 3/02

(52) U.S. Cl. 369/100; 428/64.4; G9B/7

(57) ABSTRACT

Information about a variation ratio of the recording power sensitivity, which varies depending on whether another recording layer is recorded or unrecorded, is recorded onto a disc control information area (DI) in advance. Moreover, based on this recording-power-sensitivity variation information, recording-power compensation is performed. The corresponding recording-power compensation method is classified into three types: (1) type in which the recording is performed by judging the recorded/unrecorded states of another layer, (2) type in which, instead of judging the recorded/unrecorded states of another layer, the recording is performed using an intermediate power of the optimum powers for both of the recorded/unrecorded states, and (3) combination of (1) and (2).

### INCORPORATION BY REFERENCE

The present application claims priority from Japanese application JP 2009-149295 filed on Jun. 24, 2009, the content of which is hereby incorporated by reference into this application.

### BACKGROUND OF THE INVENTION

The present invention relates to a multilayered optical disc having a plurality of recording layers, and a recording method for the multilayered optical disc having the plurality of recording layers.

FIG. 2 is a diagram for schematically illustrating the cross-sectional structure of a conventional multilayered optical disc, and the principle based on which information about each recording layer is recorded/reproduced in a selective manner. In the present conventional embodiment, the recording medium includes five recording layers in total (i.e., first recording layer 411, second recording layer 412, third recording layer 413, fourth recording layer 414, and fifth recording layer 415). For example, when trying to access recorded information about the second recording layer 412 with the use of this five-layer recording medium, the position of an objective lens 30 is controlled, thereby positioning the position of an optical spot 32 onto the second recording layer 412. At this time, a converging light beam 31, which is in the course of being focused by the objective lens 30, passes through the semitransparent first recording layer 411. On this first recording layer 411, however, the light-beam diameter of the converging light beam 31 is sufficiently larger as compared with the diameter of the optical spot 32 on the second recording layer 412. This condition makes it impossible to analyze and reproduce recorded information on the semitransparent first recording layer 411 with the use of this converging light beam 31. Also, since the light-beam diameter is sufficiently larger on the semitransparent first recording layer 411, the per-unit-area light intensity becomes relatively smaller thereon. Accordingly, there exists no necessity for worrying about a crash of the information on the first recording layer 411 at the time of the recording thereon. In this way, the recording/reproduction of the information onto/from the second recording layer 412, which is positioned on the farther side than the first recording layer 411, is implemented without suffering from the influence of the first recording layer 411.

Similarly, when recording/reproducing information about the fifth recording layer 415, the position of the objective lens 30 is controlled, thereby positioning the position of the optical spot 32 onto the fifth recording layer 415. Here, the light-beam diameter of the converging light beam 31 on a recording layer which is adjacent to the recording layer targeted for the recording/reproduction becomes equal to [2d×(NA/n)/(1−(NA/n) ̂2) ̂ (1/2)], when letting the interlayer spacing be d, numerical aperture of the objective lens be NA, wavelength of the light be λ, and refractivity of the interlayer transparent layer be n. For example, when d is equal to 8 μm, and NA is equal to 0.85, the above-described light-beam diameter becomes equal to about 10 μm. In comparison with the diameter λ/NA=470 nm of the optical spot 32 on the targeting layer at the time when the wavelength λ is equal to 400 nm, this 10-μm light-beam diameter turns out to be more than 20 times larger in diameter, and more than 400 times wider in area. In JP-A-05-101398, the detailed description has been given concerning the condition under which, as described above, the recording/reproduction is performed onto/from an optical recording medium having a plurality of recording layers without suffering from the influence of another recording layer.

In an optical disc having a plurality of recording layers like this, the following problem exists: When recording information onto a farther-side layer which is positioned on the farther side when seen from a light incident side, a difference occurs in the effective transmittance of a nearer-side layer between a case where the information is recorded onto the farther-side layer via an unrecorded area on the nearer-side layer and a case where the information is recorded onto the farther-side layer via a recorded area on the nearer-side layer. As a result of this difference in the effective transmittance of the nearer-side layer, a difference occurs in the laser power which finds it possible to reach the farther-side layer eventually. FIG. 5A and FIG. 5B illustrate this problem schematically. FIG. 5A illustrates a manner in which the optical spot is focused on an n-th recording layer (i.e., farther-side n-th layer). FIG. 5B illustrates a manner in which, when the optical spot is focused on the farther-side n-th layer, the light beam passes through an m-th recording layer (i.e., nearer-side m-th layer) which is positioned on the nearer side than the farther-side n-th layer. The longitudinal lines in the drawing indicate recording tracks formed on the farther-side n-th layer. The area 431 means a area in which no information is recorded (i.e., unrecorded area); whereas the area 432 means a area in which some information is recorded (i.e., recorded area). In the case of the Blu-ray Disc, the track pitch is equal to 0.32 μm, and the light which has entered the nearer-side m-th layer passes through the nearer-side m-th layer in such a manner that the light expands up to a range including about 100 tracks (although this value depends on the distance from the farther-side n-th layer as well). Since the transmittance differs between the recorded area and the unrecorded area, the transmission light-amount comes to differ therebetween even in a case where the same light beam passes therethrough. Namely, it turns out that the effective transmittance of the nearer-side m-th layer varies depending on the ratio between areas of the recorded area and the unrecorded area which exist on the nearer-side m-th layer.

In JP-A-2003-109217, the following disclosure has been made in response to the above-described problem: The recording medium is configured so that the difference in the transmittance between the unrecorded area and the recorded area on the nearer-side m-th layer becomes lower than a constant value. The implementation of this configuration has made it possible to perform the recording onto the farther-side n-th layer using a constant recording power and regardless of the recording state of the nearer-side m-th layer.

As is described in JP-A-2003-109217, it is desirable that, when optical design of the nearer-side m-th layer is performed, the transmittance be prevented from varying between the unrecorded area and the recorded area. Usually, however, an about a-few-% to 10-% extent of transmittance difference is caused to occur between the unrecorded area 431 and the recorded area 432 due to various factors. Here, representatives of these various factors are a medium's manufacturing variation and a medium's design error. Also, even if the transmittances of the nearer-side m-th layer can be made equal to each other, the reflectivities are different therebetween. Accordingly, in some cases, the quality of a reproduced signal from the farther-side n-th layer is caused to vary due to the influence of a reflected light from the nearer-side m-th layer.

Consequently, in an actual medium, some extent of transmittance difference exists between the unrecorded area 431 and the recorded area 432. Namely, as illustrated in FIG. 5A and FIG. 5B, the difference exists in the effective transmittance of the nearer-side m-th layer between the case where the information is recorded onto the farther-side n-th layer via the unrecorded area 431 on the nearer-side m-th layer and the case where the information is recorded onto the farther-side n-th layer via the recorded area 432 on the nearer-side m-th layer. As a result of this difference in the effective transmittance of the nearer-side m-th layer, the difference occurs in the laser power which finds it possible to reach the farther-side n-th layer eventually. More accurately speaking, the effective transmittance of the nearer-side m-th layer at the time when the optical spot 321 is focused on the farther-side n-th layer does not vary in a two-valued manner. Instead, the effective transmittance of the nearer-side m-th layer varies continuously in correspondence with the area ratio between the unrecorded area 431 and the recorded area 432 which occupy the light beam 322 on the nearer-side m-th layer.

The following description indicates an example of influences that this phenomenon exerts onto the recording condition learning. FIG. 3 is a diagram for illustrating the relationship between the recoding power and the jitter (i.e., recorded-signal quality) at the time when the recording/reproduction is performed onto/from a farther-side L0 layer in the case of a two-layer recordable-type optical disc. This relationship is illustrated in a manner of being classified into a case where a nearer-side L1 layer is unrecorded and a case where the nearer-side L1 layer is recorded. The limit equalizer used in the Blu-ray Disc as the standard device is applied for the signal processing method when a reproduced signal is evaluated. The reproduced signal is represented as the largeness/smallness of the signal jitter value. In this measurement, when the entire area of the nearer-side L1 layer is unrecorded, the optimum recording power, i.e., the recording power at which the jitter becomes its minimum, has turned out to be 7.1 mW. Also, the jitter at this time has turned out to be 6.7%. Meanwhile, when the entire area of the L1 layer is recorded, the optimum recording power has turned out to be 7.5 mW. Namely, the optimum recording power in the case where the L1 layer is recorded shifts to the higher-power side by the amount of about 7% as compared with the optimum recording power in the case where the L1 layer is unrecorded. If, in the case where the L1 layer is recorded, the recording were to be performed using the 7.1 mW optimum recording power in the case where the L1 layer is unrecorded, the jitter becomes equal to 7.0%. Accordingly, it turns out that the jitter increases by the amount of 0.3% as compared with the case where the optimum recording power is used.

For example, this result means the following phenomenon: Assume that the portion on the L1 layer through which the laser light passes is unrecorded when performing the recording condition learning with respect to the L0 layer, and that the recording is performed onto the entire L0 layer using the optimum recording power determined in this case. At this time, the recording can be performed without any problems when the portion on the L1 layer through which the laser light passes is unrecorded. If, however, the portion is recorded, an increase arises in the jitter of the reproduced signal of data recorded on the L0 layer. Namely, a reduction arises in the effective recording margin. Accordingly, in the method of JP-A-2003-109217, the effective recording margin becomes smaller. This phenomenon has made it difficult to perform the recording over the entire farther-side layer with a high reliability using a constant recording power.

In JP-A-2005-038584 and JP-A-2004-327038, the disclosure has been made concerning conventional embodiments for avoiding the above-described problem that the result of the recording condition learning varies depending on the recorded/unrecorded states of the nearer-side layer (L1). In these documents, the learning is performed in a state where the nearer-side layer is always unrecorded. This is implemented by setting test areas for the optimum recording power control over a plurality of recording layers so that these test areas do not overlap with each other. Also, in JP-A-2008-192258, the problem of the error in the optimum recording power control is avoided by employing the following scheme: Namely, the recording power is learned in both of a case where another layer is in the recorded state and a case where another layer is in the unrecorded state. Moreover, the average value of the recording powers learned is assumed.

### SUMMARY OF THE INVENTION

In JP-A-2005-038584 and JP-A-2004-327038, the disclosure has been made concerning the above-described scheme for setting the test areas for the optimum recording power control over the plurality of recording layers so that radial positions of these test areas become different from each other. Nevertheless, if this scheme is applied to a multilayered optical disc having a plurality of (three or more) recording layers, the following problem has existed:

In both of the above-described prior art documents, there is provided the method for preventing the learning result on the learning areas from being influenced by the presence or absence of the recording on the nearer-side layer. This method, however, finds it impossible to solve the problem that the optimum recording power on the user data area is influenced by the presence or absence of the recording on the nearer-side layer. In particular, in a multilayered optical disc having three or more recording layers, when performing the recording onto the farther-side layer positioned on the farther side when seen from the light incident surface, the recording is performed through the two or more recording layers positioned on the nearer side. As a result, the influence of the recording/unrecording on the nearer-side layer becomes more than two times influential. Consequently, the adjustment of the optimum recording power on the user data area is an important problem.

It is a first object of the present invention to provide a multilayered optical disc which has three or more recording layers, and onto which the recording is implementable in such a manner that the laser irradiation power onto each recording layer is controlled appropriately.

Also, it is a second object of the present invention to provide a recording method for the multilayered optical disc onto which the recording is implementable in such a manner that the laser irradiation power onto each recording layer is controlled appropriately.

In order to accomplish the first object of the present invention, the following units and methods are devised and employed.

(1) A multilayered optical disc including at least a first recording layer and a second recording layer, the second recording layer being positioned on the side of a light incident surface when seen from the first recording layer, wherein sensitivity compensation information is recorded in advance into a disc control information area (DI) of the multilayered optical disc, the sensitivity compensation information being about the ratio between the recording power sensitivity of the first recording layer in a case where the second recording layer is unrecorded and the recording power sensitivity of the first recording layer in a case where the second recording layer is recorded.

The employment of this configuration makes it possible to record the optimum recording power, which is determined as a result of the recording power learning on a area such as an OPC (: Optimum Power Control) area, in such a manner that the optimum recording power is compensated in correspondence with the recorded/unrecorded states of another layer. Accordingly, this compensated recording makes it possible to enhance reliability of the recording quality in a user recording area.

(2) A multilayered optical disc including N (N≧3) layers of recording layers, wherein sensitivity compensation information is recorded in advance into a disc control information area (DI) of the multilayered optical disc with respect to a j-th recording layer and a k-th recording layer, the j-th recording layer excluding a recording layer positioned on the farthest side from a light incident surface, the k-th recording layer being positioned on the farther side from the light incident surface than the j-th recording layer, the sensitivity compensation information being about the ratio between the recording power sensitivity of the k-th recording layer in a case where the j-th recording layer is unrecorded and the recording power sensitivity of the k-th recording layer in a case where the j-th recording layer is recorded.

(3) The above-described sensitivity compensation information is recorded in a plurality of types in correspondence with the above-described j.

or

(4) The above-described sensitivity compensation information is recorded in a plurality of types in correspondence with a combination of the above-described j and k.

The employment of this configuration makes it possible to record the optimum recording power, which is determined as a result of the recording power learning on a area such as an optical OPC (: Optimum Power Control) area having three or more layers, in such a manner that the optimum recording power is compensated in correspondence with a combination of the recorded/unrecorded states of each layer. Accordingly, this compensated recording makes it possible to enhance reliability of the recording quality in a user recording area.

Physically, the sensitivity variation ratio varies depending on not the recording layer employed as the recording target, but the recording state of the recording layer (i.e., j-th layer) which is positioned on the nearer side to the light incident surface than the recording target layer. This configuration makes it possible to acquire information necessary for the compensation only if the compensation information for j can be acquired. Namely, by omitting k-dependent information, i.e., by recording, as the sensitivity compensation information, the average value or representative value of sensitivity compensation values for a plurality of ks, it becomes possible to save the data amount of the information to be described onto the disc control information area, and to reduce a complexity at the time of control down to the smallest degree.

(5) When letting the ratio of optimum recording power in the case where the above-described recording layer is recorded with respect to the optimum recording power in the case where the recording layer is unrecorded be Q, a constant A for specifying the range of Q is determined in advance, and Q is so set as to fall into the range of 1±A.

At what value the value of this A should be determined depends on recording characteristics (i.e., recording power margin) of the recording medium. In the case of the recording-type DVD or Blu-ray Disc, the recording power margin is equal to about ±10% to 15%. Of this value, an about 5% to 10% variation error needs to be expected due to factors such as recording-power-learning accuracy, in-disc sensitivity nonuniformity, power control error, and servo error. On account of this necessity, the error in the recording/unrecording per one recording layer needs to be suppressed down to a value resulting from subtracting the above-described variation error from the recording power margin, i.e., 5% to 10% at the worst. Practically, this value needs to be further suppressed down to about 3% to 5% or less, considering that this value will exert its influence onto the recording-power-learning accuracy itself as well. Namely, it is desirable that A be set at the value of an about 0.03 to 0.05.

(6) Assuming that, of the N layers of recording layers, the recording layer positioned on the farthest side from the light incident plan is a 1st recording layer, and that a recording layer positioned on the nearest side to the light incident surface is an N-th recording layer, and when letting the ratio between optimum recording power of a recording layer in a case where an i-th recording layer is unrecorded and the optimum recording power of the recording layer in a case where the i-th recording layer is recorded be Qi, the recording layer being positioned on the farther side from the light incident surface than the i-th recording layer, with respect to an arbitrary j from 2 to N,

$${\prod }_{i = j}^{N} Qi \qquad ( Expression 1 )$$

a constant B for specifying the range of the Expression 1 is determined in advance,

$${\prod }_{i = j}^{N} Qi \qquad ( Expression 1 )$$

the Expression 1 being so set as to fall into the range of 1±B.

This

$${\prod }_{i = j}^{N} Qi \qquad ( Expression 1 )$$

indicates variation amounts in the recording power sensitivities of the j-th recording layer to the N-th recording layer in dependence with the recording states of the j-th recording layer to the N-th recording layer. Being similar to Qi for each recording layer, the variation amounts in the recording power sensitivities are factors which substantially reduce the recording characteristics (i.e., recording power margin) of the recording medium. In the case of the recording-type DVD or Blu-ray Disc, the recording power margin is equal to about ±10% to 15%. Of this value, an about 5% to 10% variation error needs to be expected due to factors such as recording-power-learning accuracy, in-disc sensitivity nonuniformity, power control error, and servo error. On account of this necessity, the accumulated value of the errors in the recording/unrecording needs to be suppressed down to a value resulting from subtracting the above-described variation error from the recording power margin, i.e., 5% to 10% at the worst. Namely, it is desirable that B be set at the value of an about 0.05 to 0.10.

(7) As the sensitivity compensation information, information about optimum recording power in the case where the recording layer is unrecorded and information about the optimum recording power in the case where the recording layer is recorded are recorded, respectively.

Otherwise,

(8) as the sensitivity compensation information, information about compensation amounts for the recording powers in the cases where the recording layer is unrecorded and recorded are recorded.

In either case of the above-described (7) and (8), the compensation amounts for the recording powers and the optimum recording powers can be acquired by making the conversion calculations on the basis of the information recorded in the disc control information area (DI).

(9) A multilayered optical disc including three or more recording layers, and information about recording power control (OFC) within a disc control information area (DI), the recording power control being executed for calculating the recording power of each recording layer, wherein power target value is set at a recording power at which degradation of user recording quality becomes its minimum, the power target value being determined by the power learning information (OPC) recorded into the disc control information area (DI), the degradation of the user recording quality being caused to occur by a variation in optimum recording power of a user recording area, the optimum recording power being dependent on a combination of recorded/unrecorded states of another recording layer.

In this method, the recording-power-adjusting target value, which makes it possible to ensure reliability of the recording quality of user data, is selected while taking into consideration the influence of a sensitivity difference which is caused to occur by the recording/unrecording of another recording layer at the time of disc manufacturing. Moreover, the recording-power-adjusting target value selected is recorded into the disc control information area (DI) as the OPC information.

In actual situations, when performing the recording onto an arbitrary recording layer, in order to minimize the influence resulting from the phenomenon that the effective recording sensitivity is caused to vary by a difference in the recording/unrecording of another recording layer, the relationship between the recording power and the recording signal quality is measured in advance using the recorded state of another recording layer as its parameter. In this way, the recording-power optimum value is determined which satisfies a predetermined recording signal quality in whatever combination of the recorded/unrecorded states. Furthermore, the recording-power optimum value is set as the optimum recording power of the user data area. On the OPC area as well, the recording power determined is caused to vary by the recorded state of another recording layer. Accordingly, information such as the OPC target power is set and recorded into the disc control information area (DI), so that the average value of the powers determined by the recording learning on the OPC area becomes the optimum recording power of the user data area.

Consequently, merely by performing the recording in accordance with the OPC information described in the disc control information area (DI), the optical-disc recording device for performing the recording using the present optical disc finds it possible to ensure the reliability of the user information without fail and regardless of the recorded/unrecorded states of the user data area.

In order to accomplish the second object of the present invention, the following units and methods are devised and employed.

(10) A recording method for a multilayered optical disc, wherein the recording method takes advantage of the multilayered optical disc including N (N≧3) layers of recording layers, wherein sensitivity compensation information is recorded in advance into a disc control information area (DI) of the multilayered optical disc with respect to a j-th recording layer and a k-th recording layer, the j-th recording layer excluding a recording layer positioned on the farthest side from a light incident surface, the k-th recording layer being positioned on the farther side from the light incident surface than the j-th recording layer, the sensitivity compensation information being about the ratio between the recording power sensitivity of the k-th recording layer in a case where the j-th recording layer is unrecorded and the recording power sensitivity of the k-th recording layer in a case where the j-th recording layer is recorded, the recording method, including a step of: recording information in such a manner that, when recording the information onto a user information area, the information is compensated in accordance with the sensitivity compensation information from a value of the recording power acquired as a result of the recording power learning (OPC).

The employment of this configuration makes it possible to record the optimum recording power, which is determined as a result of the recording power learning on a area such as an OPC (: Optimum Power Control) area, in such a manner that the optimum recording power is compensated in correspondence with the recorded/unrecorded states of another layer. Accordingly, this compensated recording makes it possible to enhance reliability of the recording quality in the user recording area.

(11) The above-described compensation of the recording power is performed in such a manner that, of all combinations of the recording states of the plurality of recording layers which exert influences onto the recording power sensitivity of the user information area, the recording power sensitivity of an average value or an intermediate value is assumed, the average value or the intermediate value being of both of a combination in which the recording power sensitivity becomes equal to its maximum and a combination in which the recording power sensitivity becomes equal to its minimum.

The employment of this configuration makes it possible to record the optimum recording power, which is determined as a result of the recording power learning on a area such as an OPC (: Optimum Power Control) area, in such a manner that the optimum recording power is compensated into a power at which the influence of the recorded/unrecorded states of another layer becomes equal to its minimum. Accordingly, this compensated recording makes it possible to enhance reliability of the recording quality in the user recording area without judging whether another layer is in the recorded state or the unrecorded state.

(12) The above-described compensation of the recording power is performed in such a manner that, of all combinations of the recording states of the plurality of recording layers which exert influences onto the recording power sensitivity of the user information area, in a case of a recording layer which can be judged as to whether the recording layer is an unrecorded area or a recorded area, a sensitivity compensation value for the judged result is employed as a recording compensation value, and, in a case of a recording layer which cannot be judged as to whether the recording layer is the unrecorded area or the recorded area, or in a case of a recording layer which has been judged to be a layer where the unrecorded area and the recorded area exist in a mixed manner, an intermediate value of a sensitivity compensation value for the unrecorded area and a sensitivity compensation value for the recorded area is employed as a recording compensation value, the recording being then performed by defining and employing a value as a resultant recording compensation value, the value being acquired by multiplying the recording compensation values of all the recording layers which exert the influences onto the recording power sensitivity of the user information area.

The employment of this configuration makes it possible to record the optimum recording power, which is determined as a result of the recording power learning on a area such as an OPC (: Optimum Power Control) area, in such a manner that, even if a layer or area which can be judged to be in the unrecorded/recorded state and a layer or area on which it is difficult to make this judgment exist in a mixed manner, the optimum recording power is compensated into a power at which the influence of the recorded/unrecorded states of another layer becomes equal to its minimum. Accordingly, this compensated recording makes it possible to enhance reliability of the recording quality in the user recording area.

In the conventional multilayered optical disc, there has existed the problem that the optimum recording power (i.e., effective recording sensitivity) is caused to vary by a difference in the recording state of the layer positioned on the light incident side. The application of the present invention, however, allows the influence of this problem to be suppressed down to the smallest possible degree, thereby making it possible to always ensure the high-quality user-data recording quality. Namely, in the present invention, it becomes possible to record the optimum recording power, which is determined as a result of the recording power learning on a area such as the OPC (: Optimum Power Control) area, in such a manner that the optimum recording power is compensated in correspondence with the recorded/unrecorded states of another layer. Accordingly, this compensated recording makes it possible to enhance reliability of the recording quality in the user recording area. In the conventional multilayered optical disc, there has existed the problem that, as the recorded areas increase in number, the recording quality becomes degraded. In contrast thereto, in the present invention, the enhancement in reliability of the recording quality always maintains the error ratio at a value of about 10⁻⁵ or less, thereby maintaining the excellent recording quality successfully. As having been described so far, according to the present invention, it becomes possible to suppress the influence exerted by the difference of whether another layer is recorded or unrecorded at the time of learning the recording power, thereby allowing the successful execution of the high-quality recording. Namely, the present invention allows the enhancement in reliability of the user recording information.

Other objects, features and advantages of the invention will become apparent from the following description of the embodiments of the invention taken in conjunction with the accompanying drawings.

### BRIEF DESCRIPTION OF THE DRAWINGS

FIG. 1A to FIG. 1C are diagrams for illustrating the overview of the present invention;

FIG. 2 is the diagram for illustrating the structure of the multilayered optical disc and the principle on which the recording/reproduction is performed in a manner where each layer is independent of each other;

FIG. 3 is the diagram for explaining the problem of the conventional multilayered optical disc;

FIG. 4 is a diagram for illustrating an example of the recording/reproduction device for the multilayered optical disc of the present invention;

FIG. 5A and FIG. 5B are the diagrams for explaining the problem of the conventional multilayered optical disc;

FIG. 6 is a diagram for illustrating the arrangement of a lead-in area and a user data area of the multilayered optical disc of the present invention;

FIGS. 7A-7C are diagrams for explaining a detection method for asymmetry, i.e., indicator for the recording-power adjustment;

FIGS. 8A-8C are diagrams for explaining a detection method for β, i.e., the indicator for the recording-power adjustment;

FIG. 9 is a diagram for illustrating a variation in the recording characteristics in a case where the entire area of another layer is unrecorded and in a case where the entire area of another layer is recorded;

FIG. 10 is a diagram for illustrating the result of the recording-power adjustment in the conventional multilayered optical disc;

FIG. 11 is a diagram for illustrating the range of the optimum recording power for the multilayered optical disc in an embodiment of the present invention;

FIG. 12 is a diagram for illustrating a variation in the recording characteristics on a recording-power adjustment area in the embodiment of the present invention;

FIG. 13 is a diagram for illustrating the result of the recording adjustment on the recording-power adjustment area in the embodiment of the present invention;

FIG. 14 is a diagram for illustrating effects of the present invention;

FIG. 15A to FIG. 15C are diagrams for illustrating a usage method for the recording-power adjustment area in the embodiment of the present invention; and

FIG. 16 is a diagram for illustrating a recording-power compensation method in the embodiment of the present invention adjustment.

### DETAILED DESCRIPTION OF THE INVENTION

Hereinafter, the detained explanation will be given below concerning embodiments of the present invention.

### Embodiment 1

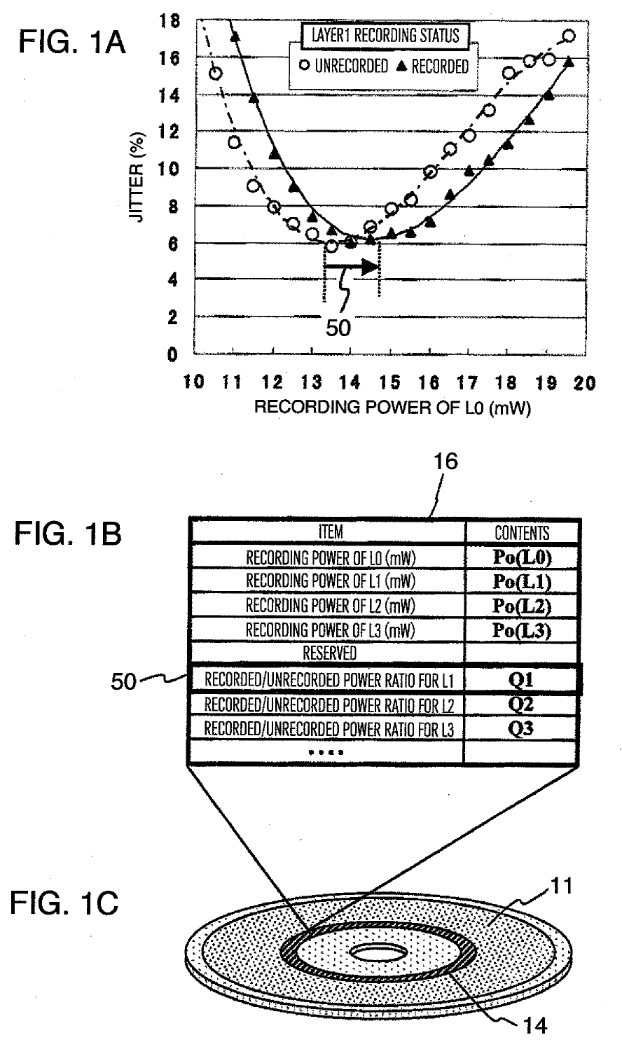

FIG. 1A to FIG. 1C are diagrams for illustrating an example of the four-layer recordable-type optical disc to which the present invention is applied. The optical disc in the present embodiment includes four recording layers, i.e., L3, L2, L1, and L0, which are arranged from the side nearest to the light incident surface. Namely, the L0 recording layer is positioned on the farthest side from the light incident surface.

FIG. 1A is the diagram for illustrating the relationship between the recoding power and the recorded-signal quality (i.e., jitter) of the L0 layer. Being similar to the case of the currently-available Blu-ray Disc, the recording capacity is equal to 25 GB, the wavelength of light used for the recording/reproduction is equal to 405 nm, and the numerical aperture (NA) of the objective lens is equal to 0.85. The jitter in the longitudinal axis, which indicates the recorded-signal quality, is measured using the limit equalizer determined based on the Blu-ray Disc Standard. As illustrated in FIG. 1A, the recording characteristics of the L0 layer differs depending on the recording state of the L1 layer which is positioned on the nearer side to the light incident surface than the L0 layer. Namely, the recording-characteristics curve in the case where the L1 layer is recorded shifts to the higher-power side as compared with the recording-characteristics curve in the case where the L1 layer is unrecorded. This shift is caused to occur by a phenomenon that the transmittance of the L1 layer is effectively lowered by a recording mark recorded on the L1 layer, and that the optical power supposed to reach the L0 layer is effectively lowered by the influence of the effective lowering in the transmittance. Namely, when the recording is performed onto a certain layer (first layer), the optimum recording power for the first layer is caused to vary by the presence or absence of the recording on a second layer positioned on the nearer side to the light incident surface than the first layer. This variation ratio 50 in the recording power depends on the characteristics of a recording film of the second layer.

In view of this situation, as the disc control information (DI) illustrated in FIG. 1B, this variation ratio 50 in the recording power is recorded in advance into a management area 14 on the disc illustrated in FIG. 1C. Here, this variation ratio is recorded in advance onto the disc as the groove wobble for indicating addresses or the like on the disc and as read-only information. In the present embodiment, the information about the optimum recording power for each layer indicates the optimum recording power in the case where another layer is unrecorded. Also, the rate of the optimum recording power (i.e., recording-power variation ratio=recording-power compensation coefficient) in the case where another layer is recorded with respect to the optimum recording power in the case where another layer is unrecorded is recorded as the variation-ratio information Qi. However, the optimum recording power in the recorded case and the optimum recording power in the unrecorded case may also be recorded, respectively. In whatever case, the use of a simple conversion expression allows acquisition of the equivalent information.

In subsequent embodiments, the detained explanation will be given concerning a drive operation at the time when the recording is actually performed onto the user area using the above-described recording-power variation ratio information recorded onto the disc. In any case, in the present embodiment, the information about the sensitivity variation caused by the presence or absence of the recording on the nearer-side layer is recorded in advance onto the disc as the disc information. This condition, when making the recording-power adjustment using the above-described drive, allows the recording power to be set and adjusted such that the influence caused by the presence or absence of the recording is taken into consideration in advance. As a result, setting accuracy for the recording power is enhanced, which makes it easy to execute the high-quality recording.

In the present embodiment, the difference caused by the presence or absence of the recording on the nearer-side transmission layer is recorded as the DI information. There also exists a method, however, that the information about the sensitivity variation is held as a two-dimensional arrangement based on a combination of the transmission layer and the recording target layer. From a first-approximation standpoint, the influence of the variation in the transmittance of the transmission layer depends on only the characteristics of the transmission layer itself. There also exists a possibility, however, that the sensitivity variation is subjected to a subtle influence by an interlayer distance between the transmission layer and the recording target layer. Accordingly, when the information about the sensitivity variation is recorded as the two-dimensional arrangement, the recording-power control becomes executable where this subtle influence is taken into consideration.

From the point-of-view of multilayered-recording compatibility, it is desirable to specify in advance the range of the recording-sensitivity compensation value to be recorded onto the disc. For example, it is desirable to set the per-layer sensitivity variation ratio at a value which falls within 5% at the maximum. Namely, it is preferable to specify 0.95≦Q≦1.05 as the range of the recording-sensitivity compensation coefficient. The reason for this is as follows: This numerical value of 5% is a value which is basically the same as the power-adjustment error range of a general optical disc device. Accordingly, if there occurs an error which exceeds 5%, there is a danger that the power-adjustment system itself may collapse. Also, the value acquired by multiplying the recording-sensitivity compensation coefficients of all the respective layers appears as the recording-power variation in the layer positioned on the farthest side from the light incident surface. Consequently, it is desirable to specify in advance the range of this multiplied value as well. It is preferable to set the range of this multiplied value at a value within about 10%, which is basically the same as the power-margin range of an ordinary optical disc.

### Embodiment 2

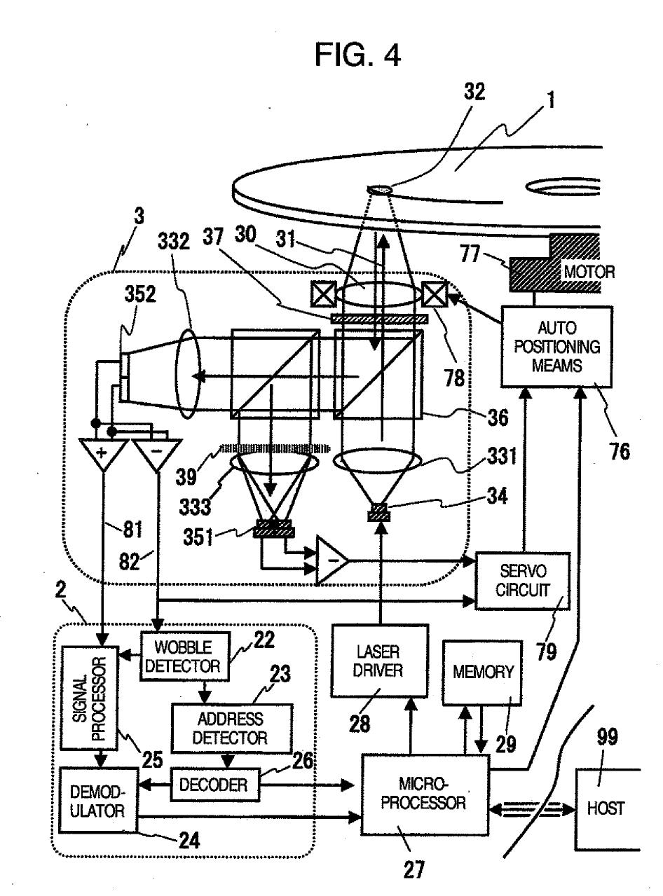

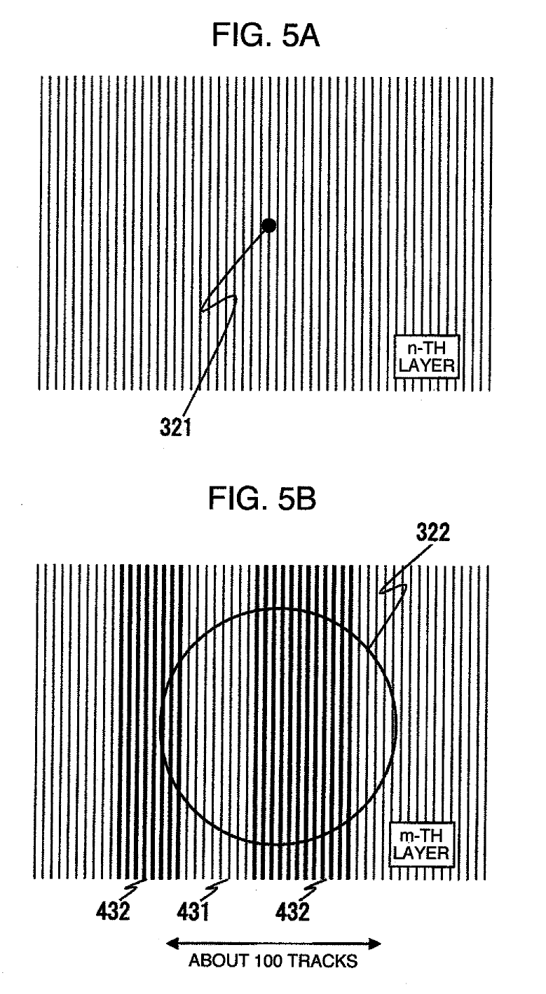

Next, FIG. 4 illustrates an example of the recording/reproduction device for performing the recording/reproduction onto/from the multilayered optical disc described in the first embodiment. A light beam (whose wavelength is equal to about 405 nm) is emitted from a laser light-source 34 which is a partial component of an optical header 3. Then, the light beam is caused to pass though a collimator lens 331, thereby being collimated into a light beam which is substantially parallel. Next, the collimated light beam is caused to pass though a beam splitter 36, an aberration compensation element 78, and an objective lens 30, thereby being projected and focused onto an optical disc 1 as a focusing light 31, and thereby forming an optical spot 32. A reflected light from the optical disc 1 is caused to pass though the beam splitter 36 and a holographic element 39, then being guided to a servo detector 351 and a signal detector 352 by detection lenses 332 and 333. Signals outputted from the respective detectors are subjected to an addition/subtraction processing, thus becoming servo signals such as a tracking error signal and a focus error signal, and then being inputted into a servo circuit 79. Based on the tracking error signal and the focus error signal acquired, the servo circuit 79 controls the entire position of an objective-lens actuator 78 and the optical header 3, thereby positioning the position of the optical spot 32 onto a target recording/reproduction area. The addition signal outputted from the signal detector 352 is inputted into a signal reproduction block 2. The inputted signal is subjected to a filtering processing, a frequency equalizing processing, and a digitizing processing by a signal processor 25. Address information formed on the disc in the form of the groove wobble is detected as a differential signal from a division detector 352, then being inputted into a wobble detector 22 inside the signal reproduction block 2. The wobble detector 22 has a function of generating clocks synchronized with the wobble signal and discriminating the wobble waveform. The wobble signal detected by the wobble detector 22 is converted into digital information by an address detector 23. After that, this digital information is subjected to an error correction processing by a decoder 26, then being detected as address information. Based on the address information detected, a start timing signal for the recording/reproduction processing is generated, thereby controlling a demodulator 24 for the user data. Simultaneously, the address information is transmitted to a controller (i.e., microprocessor) 27 as well, then being used for the access or the like.

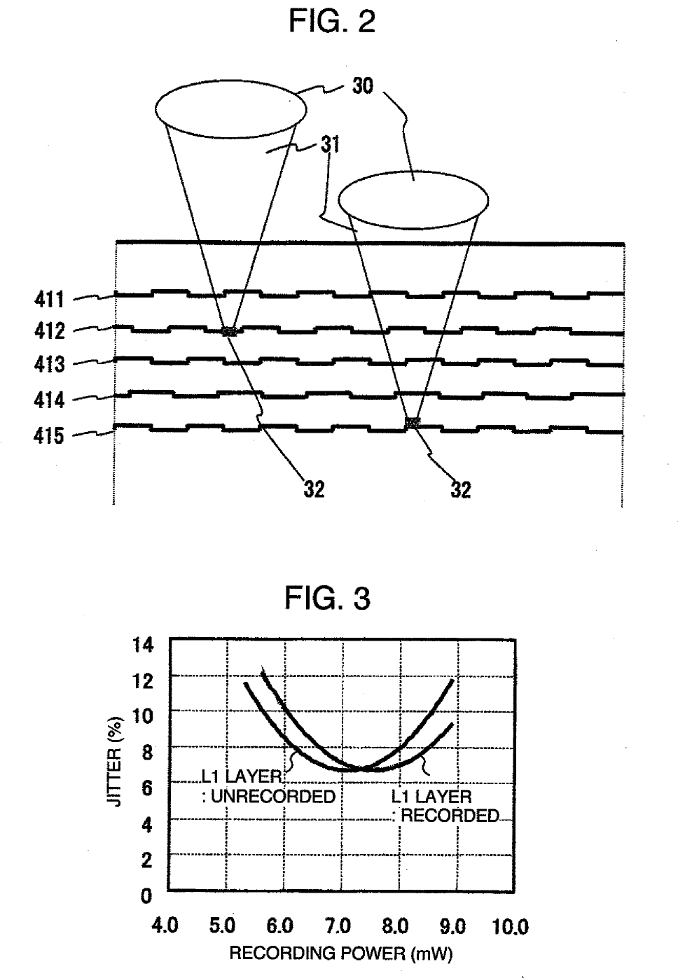

The method for performing the recording/reproduction onto/from the multilayered optical disc using the optical-disc recording/reproduction device like this is basically the same as the method described in the conventional technologies. For example, in the case of accessing the five-layer recording medium illustrated in FIG. 2, the position of the objective lens 30 is controlled, thereby positioning the position of the optical spot 32 onto a target recording layer (e.g., fifth recording layer). Namely, the optical spot lies in the focused state on the target recording layer. At this time, the converging light beam 31, which is in the course of being focused by the objective lens 30, passes through the other semitransparent recording layers (e.g., fourth layer and third layer) positioned on the nearer side. On these other recording layers, however, the light-beam diameter of the converging light beam 31 is sufficiently larger as compared with the diameter of the optical spot 32 on the target recording layer. This condition makes it impossible to analyze and reproduce the recorded information on the other semitransparent recording layers with the use of this converging light beam 31. Namely, it is possible to reproduce the information on the target layer without suffering from the influence of the information on the other layers. Also, since the light-beam diameter is sufficiently larger on the recording layers other than the target layer, the per-unit-area light intensity becomes relatively smaller thereon. Accordingly, at the time of the recording as well, there exists no necessity for worrying about a crash of the information on the recording layers other than the target layer. In this way, the recording/reproduction of the information on the multilayered optical disc is implemented.

The general methods for learning the recording power using the recording/reproduction device like this are a method of detecting the asymmetry of a signal as illustrated in FIGS. 7A-7C and FIGS. 8A-8C, and a method of evaluating the power dependence of amplitude (modulation) of a signal. FIGS. 7A-7C illustrate an indicator which is referred to as “asymmetry” in general, and a method of measuring amplitudes from the center of eye-pattern of a signal to upper-side and lower-side envelopes of the signal. Letting the amplitude from the upper-side (space-side) envelope to the center of the eye-pattern be A, and letting the amplitude from the lower-side (mark-side) envelope to the center of the eye-pattern be B, the asymmetry is defined as being (A−B)/(A+B). As the recording power becomes larger, the asymmetry varies from a negative value to a positive value. In some cases, the asymmetry under the recording condition with the optimum power exhibits a slight amount of (i.e., a few %) offset depending on characteristics of the optical-disc recording film, but the optimum power substantially lies in proximity to zero. FIGS. 8A-8C illustrate an evaluation indicator which is referred to as “β”. In this case, instead of determining the center of the eye-pattern, the DC component is eliminated using a high pass filter. Moreover, the upper-side and the lower-side envelope amplitudes A1 and A2 are determined with the AC-coupled zero point selected as the criterion, then determining β=(A1−A2)/(A1+A2). Although there is a slight difference between the two methodologies, what is common to both methodologies is that the optimum power lies in proximity to zero. In many cases, one of the two methodologies is selected depending on configuration of circuit system of the device. No explanation will be given here concerning the method of evaluating the power dependence of amplitude (modulation) of a signal. Since, in this method, the DC amplitude is detected, the detection accuracy is apt to become worse in a system like the multilayered optical disc where the influence of a leakage light and stray light is likely to become influential.

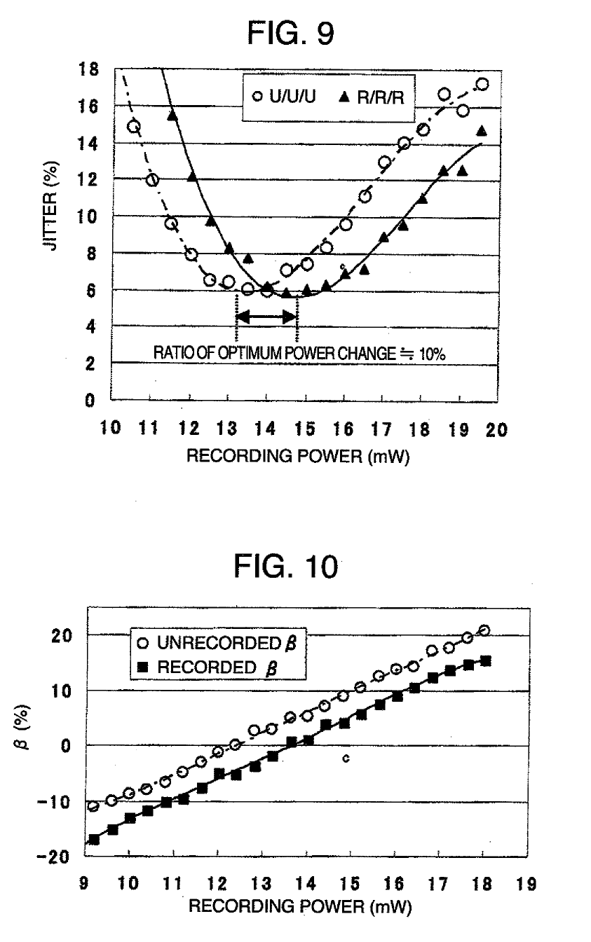

Next, FIG. 9 illustrates an example where the recorded-signal quality of the four-layer recordable-type optical disc illustrated in the first embodiment is evaluated as the jitter. This example illustrates the recording characteristics of the L0 layer positioned on the farthest side from the light incident surface. The recording characteristics (i.e., recording margin curve) of the farthest-side target layer differs significantly between a case where all of the three layers L1, L2, and L3 positioned on the nearer side are in the recorded state and a case where all of the three layers L1, L2, and L3 are in the unrecorded state. The cause for this phenomenon is as follows: When recording information onto a farther-side layer which is positioned on the farther side when seen from the light incident side, a difference occurs in the effective transmittance of a nearer-side layer between a case where the information is recorded onto the farther-side layer via an unrecorded area on the nearer-side layer and a case where the information is recorded onto the farther-side layer via a recorded area on the nearer-side layer. As a result of this difference in the effective transmittance of the nearer-side layer, a difference occurs in the laser power which finds it possible to reach the farther-side layer eventually. Namely, the cause for the variation in the recording characteristics is that the recording power sensitivity differs effectively, and that the effective recording power varies.

FIG. 10 illustrates an example where the β value of the recorded information is evaluated which is recorded onto the user data area of the farthest-side L0 layer. If the information is recorded onto the nearer-side two layers, the β value is lowered. Namely, the optimum recording power shifts to the relatively-higher-power side, thereby lowering the effective recording power. In the optical disc in the present embodiment, this variation in terms of the recording power is equal to 10% at the maximum.

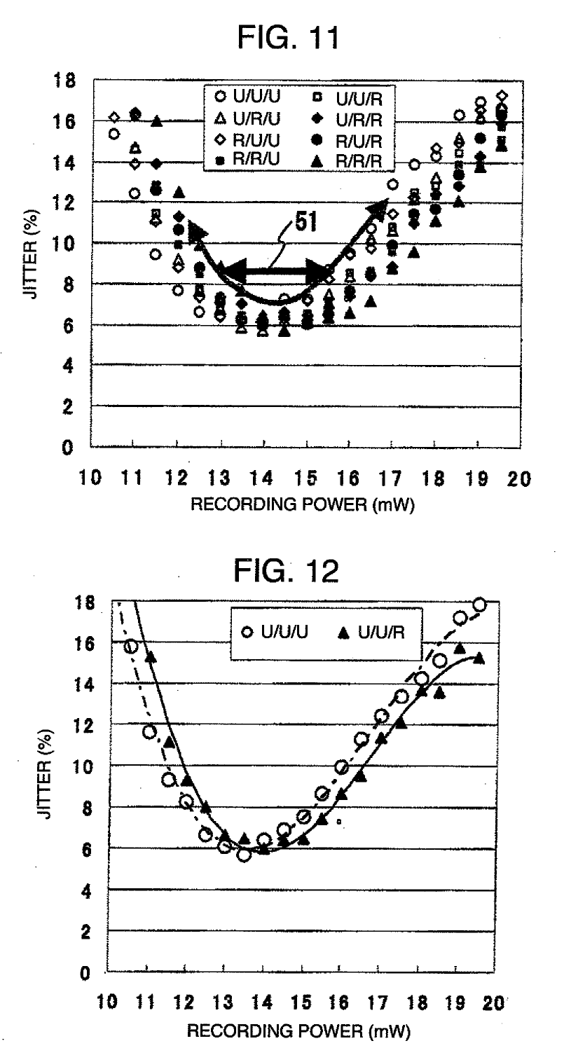

Being similar to FIG. 9, FIG. 11 illustrates the recording characteristics of the L0 layer positioned on the farthest side from the light incident surface. The recording characteristics, however, are recording characteristics for eight states which are equivalent to all the combinations of the recorded/unrecorded states of L1, L2, and L3 layers positioned on the nearer side. The recording characteristics (i.e., recording power) vary depending on the recording states of each layer. Assuming envelopes for the recording characteristics of each layer, however, makes it possible to acquire a power range, i.e., a power margin 51 in which the sufficiently-high recording quality is made available. Accordingly, by setting the recording power in the drive into the range of this power margin 51, it becomes possible to always implement the high-quality recording independently of the recording states of another layer. Nevertheless, actually measuring the recording characteristics by implementing the combination of all the recordings/reproductions of the other layers (in order to derive the range of this power margin 51 using the actual drive) is not realistic from the point-of-view of wastes of the learning time and recording areas. In view of this situation, in the present embodiment, a method for estimating this power-margin range by taking advantage of the power-sensitivity variation ratio information (Qi) is devised and applied. Here, the power-sensitivity variation ratio information (Qi) is recorded in advance onto the disc as the disc control information (DI), and corresponds to the recorded/unrecorded states of each layer.

Concretely, in the multilayered optical disc including N (N=4 in the present embodiment) layers of recording layers, the influences of the transmission layers positioned on the nearer side to the light incident surface than the recording target (j-th) layer are integrated with each other. As a result, the recording-sensitivity compensation coefficient (i.e., recording-power variation ratio) is also represented by the product of the recording-power compensation coefficients of all the respective layers. Since the recording-sensitivity compensation coefficient in the first embodiment is defined selecting the unrecorded state as its criterion, the recording-sensitivity compensation coefficient for the unrecorded state is equal to 1. Accordingly, when letting the recording-sensitivity compensation value be Qi, the compensation coefficient for a combination in which the integrated recording-sensitivity compensation value becomes its maximum is given by the following Expression 2:

$${\prod }_{i = j + 1}^{N} max ( Qi , 1 ) \qquad ( Expression 2 )$$

Meanwhile, the compensation coefficient for a combination in which the integrated recording-sensitivity compensation value becomes its minimum is given by the following Expression 3:

$${\prod }_{i = j + 1}^{N} min ( Qi , 1 ) \qquad ( Expression 3 )$$

Consequently, an average value (i.e., intermediate value) of both of the compensation coefficients is defined as the resultant compensation coefficient. This definition makes it possible to acquire the recording-power compensation value, which is equivalent to the intermediate value between the case where the maximum recording power is necessary for the combination of the recorded/unrecorded states of each layer (i.e., the product of the recording-power compensation coefficients is its maximum) and the case where the minimum recording power is necessary for the combination of the recorded/unrecorded states of each layer (i.e., the product of the recording-power compensation coefficients is its minimum). This intermediate value substantially coincides with the median value of the power margin 51 in FIG. 11. Accordingly, it becomes possible to set the recording power in the drive into the range of the power margin 51 without performing, within the drive, the evaluation of the recording characteristics corresponding to the recorded/unrecorded states of each layer. This setting always allows the implementation of the high-quality recording independently of the recording states of another layer.

Here, the recording-power compensation value is defined selecting, as its criterion, the optimum recording power corresponding to the case where another layer is in the unrecorded state. This condition requires that the optimum recording power in the case where another layer is in the unrecorded state be determined at the time of learning/adjusting the optimum recording power. FIG. 12 is a diagram for illustrating the variation in the recording-power margin on a recording-power adjustment area (i.e., OPC area) of the multilayered optical disc in the embodiment of the present invention. On the recording-power adjustment area, the recording state of another layer is controlled appropriately. As a result, the variation amount of the recording power is not so large as the ordinary user area. Accordingly, it is possible to obtain the value which is substantially the same as the optimum recording power in the case where another layer is in the unrecorded state (almost negligible as compared with FIG. 9). In a third embodiment, the detained explanation will be given concerning another example of the method for allowing the optimum recording power corresponding to the unrecorded state to be determined without fail on the recording-power adjustment area.

In this way, when actually performing the recording onto the user area using the optimum recording power determined, the recording is performed using a value which is acquired by multiplying the determined optimum recording power by the average value of both of the above-described compensation coefficients, i.e.,

$$( {\prod }_{i = j + 1}^{N} max ( Qi , 1 ) + {\prod }_{i = j + 1}^{N} min ( Qi , 1 ) ) / 2 \qquad ( Expression 4 )$$

In the present embodiment, when the recording is performed onto the L0 layer, the above-described value acquired by the multiplication has turned out to be 1.05 (+5%). This result means that, by performing the recording using the recording power with the about 5% increase, it becomes possible to perform the recording only with a 5% or less power error at the largest for both of the area where the recording power sensitivity is its maximum and the area where the recording power sensitivity is its minimum. This result is in contrast to the fact that, in the case where all of the nearer-side layers are in the recorded state, the necessary power increases by the amount of 10% as compared with the case where all of the nearer-side layers are in the unrecorded state. Since, in the multilayered optical disc of the present invention, the essential recording-power margin is equal to about ±13%, this 5% error is tolerable. If, however, the recording method of the present invention is not applied, it turns out that the 10% power error will occur, and that the margin seldom exists. This consequence becomes a cause for permitting some other outer disturbance such as disc tilting to give rise to an additional error.

FIG. 14 illustrates an example where the quality of recoded data is evaluated between the case where the recording is performed using the recording method of the present invention and the case where the recording is performed using the conventional recording method. The longitudinal axis denotes the symbol error rate. The lower the symbol error rate becomes, the higher the recording quality becomes. In the present invention, the error ratio is maintained at a value of about 10⁻⁵ or less independently of the recorded rate, thereby making it possible to maintain the excellent recording quality. In the conventional recording method, however, the error ratio increases as the recorded rate increases. This phenomenon indicates the following: In the conventional method, the extent in which the recording power moves away from the optimum recording power heightens as the recorded rate increases. Then, the resultant reduction in the optical transmittance on another layer causes the recording to be performed such that the effective recording power runs short, and the recording quality lowers accordingly. Namely, the application of the present invention always allows the execution of the high-quality recording of the user data independently of the recorded/unrecorded states of another layer.

### Embodiment 3

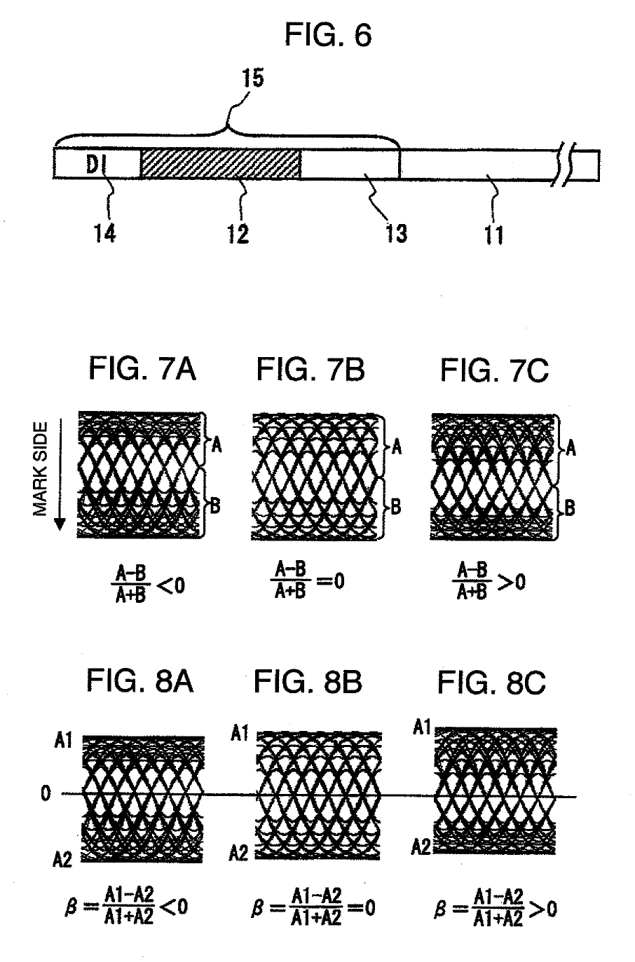

FIG. 6 illustrates the outline of a manner of the arrangement of a user data area 11 and a test area 12 for learning/adjusting the recording/reproduction condition on the recording power in the multilayered optical disc of the present invention. In the present embodiment, the test area 12 is disposed on the inner-circumference side than the user data area 11.

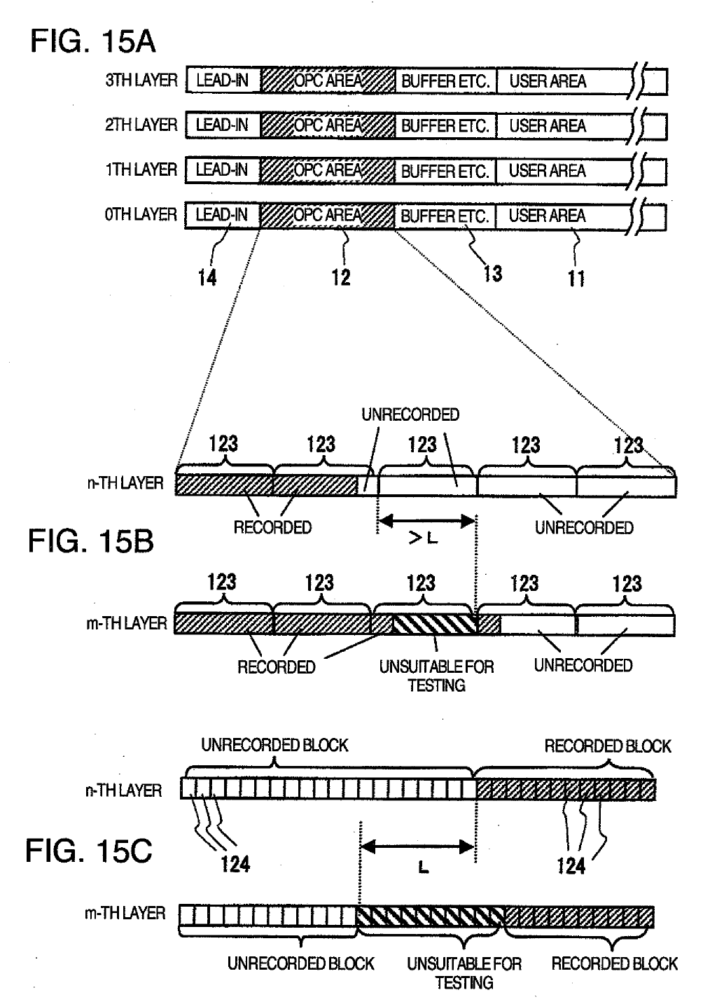

FIG. 15A to FIG. 15C illustrate the details of how the respective areas are disposed on the multilayered optical disc (four-layer optical disc in the present embodiment). FIG. 15A illustrates how the respective areas are disposed on the plurality of recording layers. Here, the respective areas are the user data area 11, the test area 12, a disc-control-information (DI) storage area 14, and an area 13 for recording a buffer area, i.e., an inter-area buffer area, and a control-information recording area. In FIG. 15A, the left side is the disc inner-circumference side, and the right side is the disc outer-circumference side. A 0-th layer is positioned on the farthest side from the light incident surface, and a 4th layer is positioned on the nearest side to the light incident surface. Namely, the fifth recording layer 415 illustrated in FIG. 2 corresponds to the 0-th layer in the present embodiment, and the first recording layer 411 illustrated in FIG. 2 corresponds to the 3rd layer in the present embodiment. The minimum value of each interlayer spacing between the respective layers is equal to about 11 μm (, although each interlayer spacing is made different on each layer basis so that the influence of interlayer crosstalk becomes its minimum). In the multilayered optical disc in the present embodiment, the test area 12 is referred to as “Optimum Power Control area (: OPC area)” in the meaning of the learning area used for controlling the recording power optimally. The test area 12 on each layer is positioned at substantially the same radial position.

FIG. 15B illustrates segmentation within the test area 12, where a plurality of segments (i.e., small areas) 123 are disposed. Each segment 123 includes a plurality of recording unit blocks. In FIG. 15B, the following segments exist in a mixed manner: A segment whose entire area is recorded, a segment whose partial area alone is recorded, and an unrecorded segment. In FIG. 15B, a partial area of the segment is recorded which is the second segment from the left on a layer (i.e., n-th layer) nearer to the light incident surface. Accordingly, the unrecorded area of the segment, which is disposed in the center of an m-th layer existing within the radial range L from the segment on the m-th layer, is judged as being a testing-unsuitable area. Consequently, the test recording is performed on the area which is the second area from the left. Within the radial range L, there is a possibility that the presence or absence of the recording on a certain layer may exert its influence on the recording characteristics of another layer. In the present embodiment, the radial length of each segment is set at a value which is larger than the radial range L. This radial range L is acquired by adding the maximum value of radial-position tolerance at the time of disc manufacturing and the maximum value (75 μm) of interlayer relative run-out to the light-beam diameter at a position which is away from the focal-point position by the amount of each interlayer spacing. The areas existing within the range of this L has a possibility of being substantially overlapped with each other, considering an expansion amount of the light-beam diameter whose radial position is on the transmission layer in the worst case of the radial-position shift and interlayer run-out caused by a variation in the disc manufacturing. Accordingly, like the present embodiment, the segment on the m-th layer (i.e., layer farther from the light incident surface) positioned within the radial range L from the recorded segment on the n-th layer, i.e., the adjacent segment, is judged as being the testing-unsuitable area. Consequently, the adjacent segment is determined not to be used for the recording test such as the power learning. This determination allows the accurate learning to be executed without suffering from the influence of the recording on the transmission layer (i.e., n-th layer).

FIG. 15C illustrates another example of the usage method for the test area 12. In this example, each segment coincides with the smallest recording unit (i.e., recording block or recording cluster). It turns out that, since the recording block is smaller than the radial range L, a plurality of recording blocks are positioned within the radial range L. Consequently, the plurality of recording blocks become testing-unsuitable blocks.

Here, the explanation will be given below concerning the radial range L. Consideration will be given to a case where, after performing the test recording onto a 2nd recording layer, the recording is performed onto a 1st recording layer which is away from the 2nd recording layer by the interlayer spacing d, and which is positioned on the farther side from the light incident surface than the 2nd recording layer. The light-beam diameter on the 1st recording layer which is away from the 2nd recording layer by the interlayer spacing d becomes equal to [2d×(NA/n)/(1−(NA/n) ̂2)̂(1/2)]≈25 μm, when taking advantage of the NA of the objective lens=0.85 and the refractivity n of the interlayer spacing layer=1.6, and when the interlayer spacing d is equal to, e.g., 30 μm. The value (200 μm), which is acquired by adding the maximum value (100 μm) of the radial-position tolerance at the time of disc manufacturing and the maximum value (75 μm) of the interlayer relative run-out to the above-described value of 25 μm, is the radial range L within which there is a possibility that the presence or absence of the recording on a certain layer may exert its influence on the recording characteristics of another layer. Consequently, the recording test such as the power learning is determined not to be performed using the test recording blocks on the 1st recording layer which are positioned within this radial range L. This determination allows the test recording to be executed on the test area on the 1st recording layer without suffering from the influence of the recording on the test area on the 2nd recording layer positioned on the nearer side to the light incident surface.

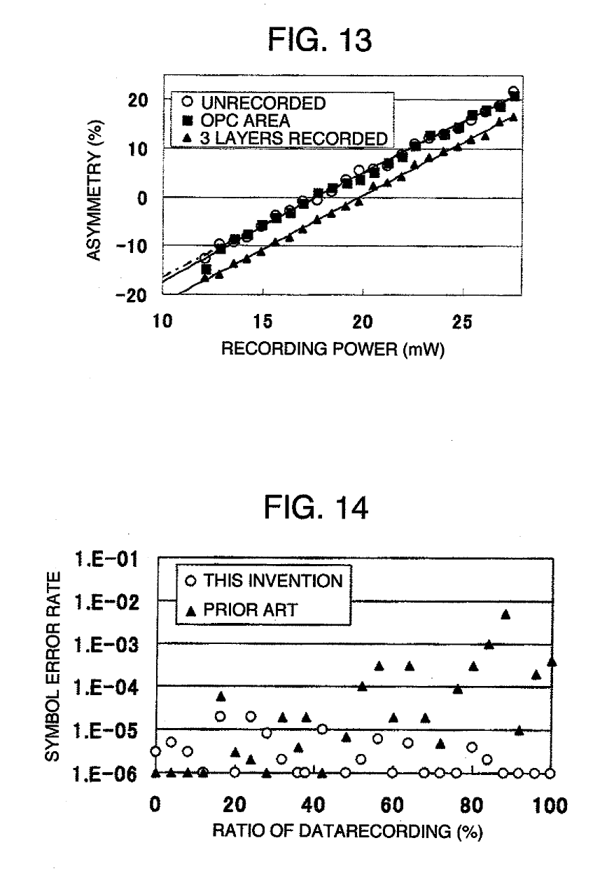

Methods for judging the testing-unsuitable blocks as being testing-unsuitable are as follows: A method of making the comparison of the block addresses among the plurality of layers, a method of recording dummy data onto the testing-unsuitable blocks in advance, and a method of recording, onto the control area (temporary disc definition structure: TDDS), information for indicating that the testing-unsuitable blocks are testing-unsuitable. From the point-of-view of inter-drive compatibility, it is desirable to combine these plurality of methods with each other. FIG. 13 is a diagram for illustrating the reproduction result of a test recording signal for the recording-power adjustment acquired by the application of the test-area (OPC-area) usage method of the present invention. The β value illustrated in FIGS. 8A-8C are employed as the indicator for the recording-power adjustment. The reproduction result shows that the β value corresponding to “unrecorded” is obtained on the OPC area, and that the optimum recording power corresponding to the unrecorded state can be determined without fail.

### Embodiment 4

In the second embodiment, the method illustrated in FIG. 11 for deriving the optimum recording power using the power-sensitivity variation ratio information (Qi) has been devised and applied. Here, the power-sensitivity variation ratio information (Qi) is recorded in advance onto the disc as the disc control information (DI), and corresponds to the recorded/unrecorded states of each layer. More concretely the optimum recording power is derived by compensating for the recording power using the recording-power compensation value which is equivalent to the intermediate value between the case where the product of the recording-power compensation coefficients of all the respective layers is its maximum and the case where the product of the recording-power compensation coefficients of all the respective layers is its minimum. Meanwhile, in the present embodiment, the more accurate power control will be performed by recognizing the recording state of each layer.

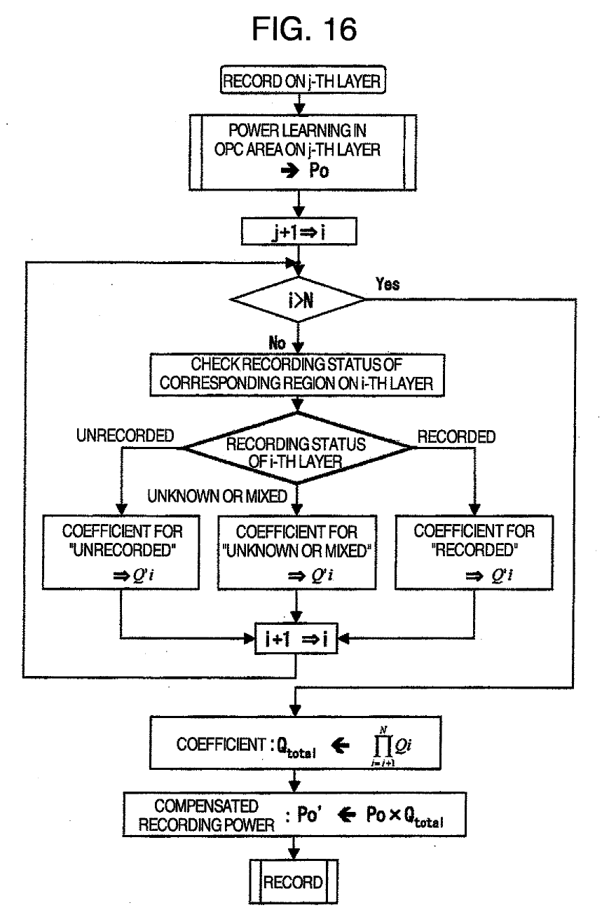

Hereinafter, in accordance with a flowchart illustrated in FIG. 16, the explanation will be given below concerning the operation in the present embodiment. When performing the recording onto a j-th layer, the optimum recording power Po is derived using the method described in the third embodiment. Here, the optimum recording power Po corresponds to the case where all of the layers positioned on the nearer side to the light incident surface than the j-th layer are in the unrecorded state. Next, it is checked whether an i-th layer, which is positioned on the nearer side to the light incident surface than the j-th layer, is in the recorded state or the unrecorded state. Then, (1) if the i-th layer is in the unrecorded state, the compensation coefficient corresponding to the unrecorded state is defined and employed as the compensation coefficient Q′i for the i-th layer, (2) if the i-th layer is in the recorded state, the compensation coefficient corresponding to the recorded state is defined and employed as the compensation coefficient Q′i for the i-th layer, or (3) if the judgment on the recorded/unrecorded states cannot be made, or if the recorded/unrecorded states exist in a mixed manner, the value equivalent to an average value of the compensation coefficient corresponding to the unrecorded state and the compensation coefficient corresponding to the recorded state is defined and employed as the compensation coefficient Q′i for the i-th layer. This processing step is applied to all of the layers positioned on the nearer side to the light incident surface than the j-th layer, thereby determining the compensation coefficients Q′i for the respective layers, j+1≦I≦N. Moreover, the product of these compensation coefficients Q′i, i.e.,

$${\prod }_{i = j + 1}^{N} {Q}^{′} i \qquad ( Expression 5 )$$

is defined and employed as total compensation coefficient Qₜₒₜₐₗ. Finally, the recording is performed under the condition that a value Po′, which is acquired by multiplying Po by this Qₜₒₜₐₗ, is defined and employed as the compensated recording power.

Here, when it is judged whether each layer is in the recorded state or the unrecorded state, information for managing the recorded/unrecorded states of each layer are used, such as recording control information, defect management information, and Space Bit Map. At this time, it is desirable that the recording state in the range be checked by taking into consideration not only the recording state of an area whose radial position is the same as that of the target recording area, but also the radius shift due to interlayer run-out and manufacturing error and size of the light beam on another layer. After the checking is made in this way, it is judged whether the range checked is in the recorded, unrecorded, or mixed state.

According to the method in the present embodiment, it becomes possible to perform the recording in such a manner that the recording power is used which is made more accurate and suitable in correspondence with the recorded/unrecorded states of each layer. Accordingly, it becomes possible to set the recording power in the drive into the range of the power margin 51. This setting always allows the implementation of the high-quality recording which is made to correspond to the recording states of another layer successfully.

### Embodiment 5

In the first and second embodiments, the method illustrated in FIG. 11 for deriving the optimum recording power using the power-sensitivity variation ratio information (Qi) has been devised and applied. Here, the power-sensitivity variation ratio information (Qi) is recorded in advance onto the disc as the disc control information (DI), and corresponds to the recorded/unrecorded states of each layer. More concretely the optimum recording power is derived by compensating for the recording power using the recording-power compensation value which is equivalent to the intermediate value between the case where the product of the recording-power compensation coefficients of all the respective layers is its maximum and the case where the product of the recording-power compensation coefficients of all the respective layers is its minimum. In contrast thereto, in the present embodiment, the target value for the optimum recording power to be determined on the recording-power adjustment area (i.e., OPC area) is set at and is made equal to the power range which is acquired by assuming the envelopes for the recording characteristics corresponding to all the combinations of all the recorded/unrecorded states positioned on the nearer side to the light incident surface than the recording target layer, i.e., the central power Po′ of the power margin 51 illustrated in FIG. 11. The recording characteristics on the OPC area are that all the layers thereon exhibit the recording characteristics close to the ones in the unrecorded state. Accordingly, the power at which the recording characteristics on the OPC area become the highest is substantially equal to the optimum recording power at the time when all the layers are in the unrecorded state. In contrast thereto, in the present embodiment, the optimum recording power is set at the central power Po′ of the power margin 51 illustrated in FIG. 11. This power differs from the power Po at which the recording characteristics on the OPC area become the highest. The target value (i.e., OPC parameter) for the recording power learning, however, is set so that the recording result of the recording power on the OPC area becomes equal to the central power Po′. Then, this target value is described and recorded onto the disc control information area (DI) in advance. In the case of this method, merely by taking advantage of the recording result of the recording power on the OPC area directly, it becomes possible to ensure the recording quality which is equivalent to the one in the second embodiment. In contrast thereto, the method explained in the fourth embodiment is inapplicable which is devised for precisely adjusting the recording power depending on whether another layer is in the recorded state or the reproduced state. However, by appropriately selecting the OPC-control target value to be recorded as the disc control information (DI), it is made possible to ensure the recording quality as is the case with the other embodiments.

If the present embodiment is represented using other technical terms, its representation is given as follows: The control target parameter for the recording power learning is set so that, when the recording is performed onto the user area using the power learning result on the recording-power learning area, the user-data signal quality (i.e., jitter) will always satisfy a predetermined quality (i.e., standard specified range).

The effects of the present invention are not limited to the embodiments explained so far. For example, it is possible that, in addition to the recordable-type recording layers, the rewritable-type recording layers are used as the recording layers of the optical disc. In the case of the rewritable-type recording layers, the use of the asymmetry and the β value does not necessarily result in the determination of the accurate power. Accordingly, it is desirable that the modulation and indicators such as ε, γ, and κ be co-used as the indicators for the recording-power adjustment OPC.

Also, although the case of the four-layer optical disc has been mainly given in the embodiments explained so far, the present invention is applicable to whatever optical discs as long as they are the three-or-more-layer multilayered optical disc.

Also, instead of being recorded onto the reproduction-specific area of the disc, such information as the recording-power variation ratio information to be recorded onto the disc may also be recorded onto the recording-capable area of the disc by disc manufacturer at the time of disc shipment. In this case, the recording of a value in agreement with the characteristics of the actually-manufactured disc becomes executable. Accordingly, there exists an advantage of becoming capable of absorbing the influence of a variation in the disc manufacturing. Also, there exists a method whereby the optical-disc drive for actually performing the recording/reproduction records the above-described differential information as a result of the disc characteristics test. In this case, there exists a merit that the combination of the disc and the drive makes it possible to absorb the variation, although there exists a demerit that the learning time within the drive will increase.

Also, in the above-described embodiments, the explanation has been mainly given concerning the case where the optical transmittance after the recording decreases, i.e., the case where the optimum recording power after the recording increases. Depending on characteristics of the recording film or polarity of the recording signal, however, there may exist a case where the optical transmittance after the recording increases, i.e., a case where the optimum recording power after the recording decreases. In this case, the effects of the present invention remain the same, although the compensation coefficient becomes smaller than 1.

It should be further understood by those skilled in the art that although the foregoing description has been made on embodiments of the invention, the invention is not limited thereto and various changes and modifications may be made without departing from the spirit of the invention and the scope of the appended claims.

1. A multilayered optical disc, comprising:
at least a first recording layer; and
a second recording layer, said second recording layer being positioned on said side of a light incident surface when seen from said first recording layer, wherein
sensitivity compensation information is recorded in advance into a disc control information area of said multilayered optical disc, said sensitivity compensation information being about said ratio between said recording power sensitivity of said first recording layer in a case where said second recording layer is unrecorded and said recording power sensitivity of said first recording layer in a case where said second recording layer is recorded.

2. A multilayered optical disc, comprising:
N (N≧3) layers of recording layers, wherein
sensitivity compensation information is recorded in advance into a disc control information area (DI) of said multilayered optical disc with respect to a j-th recording layer and a k-th recording layer,
said j-th recording layer excluding a recording layer positioned on the farthest side from a light incident surface, said k-th recording layer being positioned on the farther side from said light incident surface than said j-th recording layer,
said sensitivity compensation information being about said ratio between said recording power sensitivity of said k-th recording layer in a case where said j-th recording layer is unrecorded and said recording power sensitivity of said k-th recording layer in a case where said j-th recording layer is recorded.

3. The multilayered optical disc according to claim 2, wherein
said sensitivity compensation information is recorded in a plurality of types in correspondence with said j.

4. The multilayered optical disc according to claim 2, wherein
said sensitivity compensation information is recorded in a plurality of types in correspondence with said j and k.

5. The multilayered optical disc according to claim 2, wherein,
when letting said ratio of optimum recording power in said case where said above-described recording layer is recorded with respect to said optimum recording power in said case where said recording layer is unrecorded be Q, a constant A for specifying said range of Q is determined in advance, and Q is so set as to fall into said range of 1±A.

6. The multilayered optical disc according to claim 2, wherein,
assuming that, of said N layers of recording layers, said recording layer positioned on the farthest side from said light incident plan is a 1st recording layer, and that a recording layer positioned on the nearest side to said light incident surface is an N-th recording layer, and
when letting said ratio between optimum recording power of a recording layer in a case where an i-th recording layer is unrecorded and said optimum recording power of said recording layer in a case where said i-th recording layer is recorded be Qi, said recording layer being positioned on the farther side from said light incident surface than said i-th recording layer,
with respect to an arbitrary j from 2 to N,
$${\prod }_{i = j}^{N} Qi \qquad ( Expression 1 )$$
a constant B for specifying said range of said Expression 1 is determined in advance,
$${\prod }_{i = j}^{N} Qi \qquad ( Expression 1 )$$
said Expression 1 being so set as to fall into said range of 1±B.

7. The multilayered optical disc according to claim 1, wherein,
as said sensitivity compensation information, information about optimum recording power in said case where said recording layer is unrecorded and information about said optimum recording power in said case where said recording layer is recorded are recorded, respectively.

8. The multilayered optical disc according to claim 1, wherein,
as said sensitivity compensation information, information about compensation amounts for said recording powers in said cases where said recording layer is unrecorded and recorded are recorded.

9. A multilayered optical disc, comprising:
three or more recording layers; and
information about recording power control (OPC) within a disc control information area (DI), said recording power control being executed for calculating said recording power of each recording layer, wherein
power target value is set at a recording power at which degradation of user recording quality becomes its minimum,
said power target value being determined by said power learning information (OPC) recorded into said disc control information area (DI),
said degradation of said user recording quality being caused to occur by a variation in optimum recording power of a user recording area, said optimum recording power being dependent on a combination of recorded/unrecorded states of another recording layer.

10. A recording method for a multilayered optical disc,
wherein
said recording method takes advantage of
said multilayered optical disc including N (N≧3) layers of recording layers, wherein sensitivity compensation information is recorded in advance into a disc control information area (DI) of said multilayered optical disc with respect to a j-th recording layer and a k-th recording layer, said j-th recording layer excluding a recording layer positioned on the farthest side from a light incident surface, said k-th recording layer being positioned on the farther side from said light incident surface than said j-th recording layer, said sensitivity compensation information being about said ratio between said recording power sensitivity of said k-th recording layer in a case where said j-th recording layer is unrecorded and said recording power sensitivity of said k-th recording layer in a case where said j-th recording layer is recorded,
said recording method, comprising a step of:
recording information such that, when recording said information onto a user information area, said information is compensated in accordance with said sensitivity compensation information from a value of said recording power acquired as a result of said recording power learning (OPC).

11. The recording method for a multilayered optical disc according to claim 10, wherein
said compensation of said recording power is performed such that, of all combinations of said recording states of said plurality of recording layers which exert influences onto said recording power sensitivity of said user information area,
said recording power sensitivity of an average value or an intermediate value is assumed, said average value or said intermediate value being of both of a combination in which said recording power sensitivity becomes equal to its maximum and a combination in which said recording power sensitivity becomes equal to its minimum.

12. The recording method for a multilayered optical disc according to claim 10, wherein
said compensation of said recording power is performed such that, of all combinations of said recording states of said plurality of recording layers which exert influences onto said recording power sensitivity of said user information area,
in a case of a recording layer which can be judged as to whether said recording layer is an unrecorded area or a recorded area, a sensitivity compensation value for said judged result is employed as a recording compensation value, and,
in a case of a recording layer which cannot be judged as to whether said recording layer is said unrecorded area or said recorded area, or in a case of a recording layer which has been judged to be a layer where said unrecorded area and said recorded area exist in a mixed manner, an intermediate value of a sensitivity compensation value for said unrecorded area and a sensitivity compensation value for said recorded area is defined and employed as a recording compensation value,
said recording being then performed by defining and employing a value as a resultant recording compensation value, said value being acquired by multiplying said recording compensation values of all said recording layers which exert said influences onto said recording power sensitivity of said user information area.

13. The recording method for a multilayered optical disc according to claim 10, wherein
said sensitivity compensation information is acquired by describing an envelop curve of recording characteristics and determining optimum recording power, said envelop curve of said recording characteristics corresponding to all combinations of said recorded or unrecorded states of said layer positioned on the nearer side to said light incident surface than said k-th recording layer.
